(19) United States
(12) Patent Application Publication
(10) Pub. No.: US 2017/0139701 A1
(43) Pub. Date: May 18, 2017

(54) Platform for Full Life-Cycle of Vehicle Relationship Management

(71) Applicant: Movimento Group, Plymouth, MI (US)

(72) Inventors: Tao Lin, Palo Alto, CA (US); Pratikkumar Desai, Santa Clara, CA (US); Mahbubul Alam, San Jose, CA (US); Rasmus Nielsen, San Jose, CA (US)

(21) Appl. No.: 15/350,275

(22) Filed: Nov. 14, 2016

Related U.S. Application Data
(60) Provisional application No. 62/254,649, filed on Nov. 12, 2015.
(60) Provisional application No. 62/306,529, filed on Mar. 10, 2016.
(60) Provisional application No. 62/319,398, filed on Apr. 7, 2016.

(51) Int. Cl. G06F 9/445; G06N 5/02

(52) U.S. Cl. CPC G06F 8/65; G06N 5/02

(57) ABSTRACT

A vehicle software update system is contemplated. The system may be utilized to facilitate Over-the-Air (OTA) software updates according to various functional requirements, the interaction of modules with other modules and/or the relationship of the modules with engines. The vehicle software update system may include a message engine, a transformation engine, an operation engine, an intelligent engine, and/or an analytical engine.

### CROSS-REFERENCE TO RELATED APPLICATIONS

This application claims the benefit of U.S. provisional Application Nos. 62/254,649, filed Nov. 12, 2015, 62/306,529, filed Mar. 10, 2016, and 62/319,398, filed Apr. 7, 2016, the disclosures of which are incorporated in their entirety by reference herein.

### TECHNICAL FIELD

The present invention relates to a platform for full life-cycle of vehicle relationship management.

### BACKGROUND

A vehicle, particularly an automobile, may require numerous software, module, programming or other computer-readable code updates throughout its life-cycle. One non-limiting aspect of the present invention relates to a platform for facilitating vehicle related updates and other management related processes.

### BRIEF DESCRIPTION OF THE DRAWINGS

FIG. 1 illustrates an architecture for a vehicle update system in accordance with one non-limiting aspect of the present invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

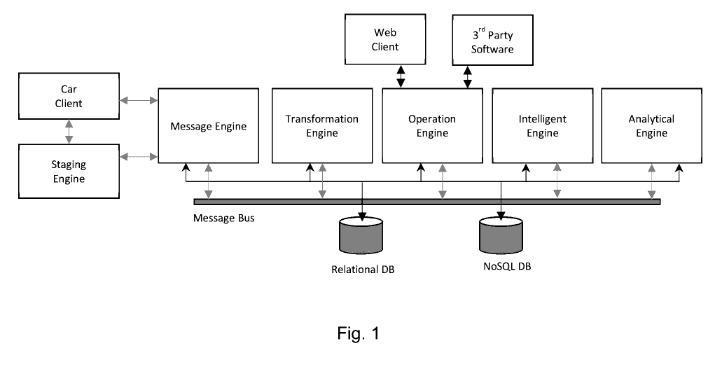

FIG. 1 illustrates an architecture for a vehicle update system in accordance with one non-limiting aspect of the present invention. This system aims to support both OTA and re-flash:
A Car Client can update software/firmware/application over-the-air; and
A Car Client can update software/firmware/application through a staging engine.

Due to the priority and the size of update software/firmware/application, battery life and other the characteristics of a vehicle, the software update might be needed with OTA or re-flash. For re-flash installation, this system can arrange a Staging Engine based on geo-location and car service. The software package to be downloaded to the vehicle will be loaded to the scheduled Staging Engine.

This system may include five engines:
Message Engine provides the end-point to communicate with a Car Client. A Message Engine supports both inbound and outbound message processing.
Transformation Engine provides the real-processing for messages. A message has head and body. Transformation Engine processes message body and Message Engine handles head.
Operation Engine supports data operations, software operations, system issue management, API management, and other interactions with a user, such as visualization and notification. Through a Web Client, a user interacts with the OTA software update system through Operation Engine. Through a Web Client, a user interacts with an Operation Engine.
Intelligent Engine provides the intelligent operations, such as packaging, software dependency checking, scheduling and monitoring, and scheduling staging engine.
Analytical Engine supports business intelligence, including reporting generation and alert detection.

The message bus provides the channel for the communication cross engines. Traditional data records will be managed by Relational database. Data such as messages, data logs, software packages, operation history will be managed by NoSQL database.

It is likely that some data, for example vehicle data, are already stored in the database of OEM. Also, the updated status of vehicles can be required by OEM as well. Therefore, the integration between the systems of OEM and software update system needs to be supported. This system will provide API management to support the communication with OEM software systems.

The API management can also support further enhancement. For example, a payment system can manage the billing based software updates based on the data retrieved from the API management.

Scalability is one of the major concerns for the design of the software update system. This system may support the connections with millions of vehicles and the communication has to be reliable. From a high level perspective, this system may be designed as a distributed environment. With separated responsibility of the engines, this system can be highly scalable. Each Message Engine can limited a number of car connections. The number of Message Engine can be adjusted based on the number of car connections.

Having Intelligent Engine and Analytical Engine separated from Operation Engine reduces computation time for Operation Engine and improves reaction time to the interaction with user.

The processes, methods and other operations associated with the engines and other features capabilities of the present invention, particularly those associated with facilitating to facilitate life-cycle management, may be facilitated with a corresponding processor executing non-transitory instructions stored within a non-transitory computer-readable medium associated therewith.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle software update system comprising:
a message engine;
a transformation engine;
an operation engine;
an intelligent engine; and
an analytical engine.
